(19) United States
(12) Patent Application Publication
(10) Pub. No.: US 2023/0256360 A1
(43) Pub. Date: Aug. 17, 2023

(54) Permeation Apparatus, System and Method

(71) Applicant: University of Connecticut, Farmington, CT (US)

(72) Inventors: Antonio P. Costa, Tolland, CT (US); Diane J. Burgess, Storrs, CT (US)

(73) Assignee: University of Connecticut, Farmington, CT (US)

(21) Appl. No.: 18/109,557

(22) Filed: Feb. 14, 2023

Related U.S. Application Data
(60) Provisional application No. 63/309,793, filed on Feb. 14, 2022.

(51) Int. Cl. B01D 19/00; B01D 69/10; B01D 71/02

(52) U.S. Cl. CPC B01D 19/0031; B01D 19/0063; B01D 69/107; B01D 71/0213; B01D 19/0068

(57) ABSTRACT

A permeate device includes at least one non-porous, gas permeable element configured for contact with a liquid flow and at least one element fabricated from a porous material configured to permit gas flow therethrough. The permeate device may include a vacuum chamber that surrounds an operative portion of a permeation zone. A method for processing a liquid flow to remove entrained gas includes providing a liquid flow that includes an initial level of entrained gas, delivering the liquid flow to a permeate device, wherein the permeate device includes (i) at least one non-porous, gas permeable element configured for direct contact with the flow; and (ii) at least one element fabricated at least in part from a porous material configured so as to permit gas flow therethrough, and applying a negative pressure to the permeate device to draw entrained gas from the flow within an operative portion of the permeate device.

### CROSS-REFERENCE TO RELATED APPLICATION

The present application claims priority benefit to a provisional application entitled “Permeation Apparatus, System and Method,” which was filed on Feb. 14, 2022, and assigned Ser. No. 63/309,793. The entire content of the foregoing provisional application is incorporated herein by reference.

### STATEMENT OF GOVERNMENT FUNDING

This invention was made with government support under U01 FD006975 awarded by the Food and Drug Administration. The government has certain rights in the invention.

### BACKGROUND

### 1. Technical Field

The present disclosure is directed to apparatus, systems and methods for permeation of gasses from a liquid flow stream through an element, structure or layer fabricated at least in part from a non-porous material. The disclosed apparatus, systems and methods have wide ranging utility and application, including for use in debubbling and degassing applications in a variety of industries, e.g., pharmaceutical, nutraceutical, cosmetics and food/beverage industries.

### 2. Background Art

Debubbling systems/technologies are known. A conventional debubbler is generally used for removal of visible bubbles from water flow streams not containing organic solvents or detergents. Of note, the presence of bubbles in system liquids can cause dispense volume anomalies in many instruments and may have severe impact on both dispense precision and analytical accuracy.

Degassing systems/technologies are also known. Degassers are generally of two types: (i) vacuum degassers, and (ii) centrifugal degassers. Generally, vacuum degassers are more efficient degassers, but have lower throughput capability. As a result, vacuum degassers are generally better suited to lower flow rate systems with high gas cuts and/or systems that are highly sensitive to entrained gas.

Currently available technologies generally use small-fiber, silicone tubing (non-porous) that must use epoxy or other potting materials. While available systems have utility, they are not compatible with a range of water/solvents which significantly limits their utility and applicability. These conventional units are also inherently limited in the maximum transmembrane pressure that can be accommodated in use, thereby further limiting the utility and applicability of such systems.

What are needed are methods and apparatus to address shortcomings of conventional debubbling/degassing systems. Preferably, the methods and apparatus provide a permeation modality that is widely compatible with water/solvent systems and can accommodate higher pressures as compared to conventional systems.

### SUMMARY

Apparatus, systems and methods are provided for permeation of gasses from a liquid flow stream through an element, structure or layer fabricated at least in part from a non-porous material. The disclosed apparatus, systems and methods have wide ranging utility and application, including for use in debubbling and degassing applications in a variety of industries, e.g., pharmaceutical, nutraceutical, cosmetics and food/beverage industries.

In an exemplary embodiment, a permeate device is provided for processing a liquid flow. The device includes (i) at least one non-porous, gas permeable element, structure or layer configured and dimensioned for direct contact with the liquid flow, and (ii) at least one element, structure or layer fabricated at least in part from a porous material or at least one element, structure or layer configured and dimensioned so as to permit gas flow therethrough. The element, structure or layer that permits gas flow therethrough is positioned outward of the at least one non-porous, gas permeable layer. The gas that passes from the liquid flow and through the at least one non-porous, gas permeable element, structure or layer is brought into fluid communication with the element, structure or layer that permits gas flow therethrough. In this way, gas is permitted to pass from the liquid flow through a first element, structure or layer based on gas permeability, and then through a second element, structure or layer based on porosity and/or structural features of the second element, e.g., predefined openings therethrough.

In an exemplary embodiment, the first element, structure or layer and the second element, structure or layer may define a permeate device subassembly.

The permeate device may further include a vacuum chamber positioned or defined outward of the first element, structure or layer and the second element, structure or layer, e.g., outward of at least a portion of the permeate device subassembly. The vacuum chamber generally surrounds or encases an operative portion of the first element, structure or layer and the second element, structure or layer. The vacuum chamber is typically in fluid communication with a vacuum pump and may include fittings or other structures to facilitate operative connection relative to the vacuum pump or other source of vacuum/negative pressure.

The first element, structure or layer, e.g., the non-porous, gas permeable layer, generally defines a cylindrical flow path for the liquid flow, although alternative geometries may be employed. The first element, structure or layer may define a substantially axial flow path or may define non-axial flow paths, e.g., within the vacuum chamber. For example, the first element, structure or layer may define a substantially serpentine or tortuous path within the vacuum chamber, thereby increasing the residence time of the liquid within the vacuum chamber.

Assembly of the permeate device is generally devoid of epoxy and/or potting material(s). For example, the permeate device may be assembled such that the vacuum chamber sealingly engages the first element, structure or layer and the second element, structure or layer without the presence of epoxy and/or potting material(s). A gasket, washer or other non-epoxy based sealing member may be interposed between (i) the structure defining the vacuum chamber and (ii) the first element, structure or layer and the second element, structure or layer, i.e., the permeate device subassembly, to facilitate sealing therebetween. The vacuum chamber may be hermetically sealed relative to the permeate device, e.g., by welding, thermocompression bonding, and/or compression and adhesion. Various welding methods may be employed, e.g., micro-plasma, electron beam, projection, friction, ultrasonic, resistance, brazing, and/or laser welding.

In an exemplary embodiment, the first element, structure or layer may be fabricated, in whole or in part, from silicone (polydimethylsiloxane) or other material(s) exhibiting desired gas permeability properties. In an exemplary embodiment, the second element, structure or layer may be fabricated, in whole or in part, from material(s) that provide structural support to the first element, structure or layer and that do not impede gas flow therethrough. For example, the second element, structure or layer may be fabricated, in whole or in part, from stainless steel, a steel alloy or a rigid plastic that includes pre-defined passage(s), e.g., apertures or channels, that permit unimpeded gas flow therethrough. Materials, such as polyetheretherketone, polyetherimide (PEI) material and stainless steel, may be implemented as component(s) in the layers or between the first/second element(s), structure(s) or layer(s).

The disclosed system can be built of or as a single, uniform component, and may be manufactured, in whole or in part, using additive manufacturing technologies. The single component and/or system can be sterilized, e.g., using gamma-irradiation or by autoclaving.

As noted above, in an exemplary embodiment, the first element, structure or layer, i.e., the at least one non-porous, gas permeable layer, of the disclosed permeate device may be fabricated, in whole or in part, from silicone.

In an exemplary embodiment, the second element, structure or layer, i.e., the at least one porous material of the disclosed permeate device, may be fabricated, in whole or in part, from a fluoropolymer, e.g., a fluoroethylene material. The fluoropolymer material may be polytetrafluoroethylene. In an exemplary embodiment, the second element, structure or layer, i.e., the at least one porous material of the disclosed permeate device, may be fabricated, in whole or in part, from polyethersulfone. In an exemplary embodiment, the second element, structure or layer, i.e., the at least one porous material of the disclosed permeate device, may be fabricated, in whole or in part, from stainless steel, a steel alloy or other metallic material that includes pre-defined apertures/channels or other openings that are configured and dimensioned to allow gas flow therethrough. In an exemplary embodiment, the second element, structure or layer, i.e., the at least one porous material of the disclosed permeate device, may be fabricated, in whole or in part, from a rigid plastic that includes pre-defined apertures/channels or other openings that are configured and dimensioned to allow gas flow therethrough.

The permeate device may further include one or more sensors positioned in association with the second element, structure or layer, i.e., the at least one porous material. The sensor(s) may be selected from the group consisting of a pressure sensor, a temperature sensor, a refractive index sensor, a gas sensor, and combinations thereof. Sensor(s) may be cleanable/reusable, single-use or a combination thereof.

The present disclosure further provides a method for processing a liquid flow to remove gas and/or bubbles, the method generally entailing: (i) providing a liquid flow that includes an initial level of gas or bubbles; (ii) delivering the liquid flow to a permeate device, wherein the permeate device includes (i) at least one non-porous, gas permeable layer configured and dimensioned for direct contact with the liquid flow, and (ii) a first element, structure or layer, i.e., at least one non-porous, gas permeable element, structure or layer, and a second element, structure or layer, i.e., at least one porous material, positioned outward of the first element, structure or layer; and (iii) applying a negative pressure to the permeate device to draw gas and/or bubbles through the first and second elements, structures and/or layers, i.e., the at least one non-porous, gas permeable element, structure or layer, and the at least one porous element, structure or layer, thereby reducing the initial level of gas or bubbles in the liquid flow to a reduced level of gas or bubbles therein.

As noted above, various materials may be used to fabricate components of the permeate device, i.e., the first/second elements, structures or layers, and/or between the first/second elements, structures and/or layers, such as polyetheretherketone, polyetherimide (PEI) material, stainless steel or a steel alloy. As also noted above, the disclosed permeate device may be built of a single, uniform component, e.g., fabricated using additive manufacturing technologies. The permeate device, e.g., the single component, can be sterilized using sterilization technologies, e.g., gamma-irradiation or by autoclaving.

The vacuum/negative pressure delivered to the permeate device may be in the 10-12 to 100 Torr pressure range. In an exemplary embodiment, an operative portion of the permeate device is positioned within a vacuum chamber, and the vacuum/negative pressure is delivered to the disclosed permeate device by applying vacuum/negative pressure to the vacuum chamber. The disclosed permeation device advantageously allows for gas to permeate through the first element, structure or layer, e.g., the silicone layer, while not disturbing the liquid flow stream.

The disclosed method may further include providing at least one mixer for mixing constituents of the liquid flow prior to delivery to the permeate device. At least one additional mixer may be providing for mixing constituents of the liquid flow after processing within the permeate device.

The disclosed method may be implemented with a permeate device that includes one or more sensors associated therewith, and the one or more sensors may be selected from the group consisting of a pressure sensor, a temperature sensor, a refractive index sensor, a gas sensor, and combinations thereof.

The permeate device employed in the disclosed method may be assembled without resort to epoxy or potting materials.

The disclosed method may be implemented with a permeate device wherein the first element, structure or layer, i.e., the at least one non-porous, gas permeable element, structure or layer of the permeate device, is fabricated, in whole or in part, from silicone, and/or wherein the second element, structure or layer, i.e., the at least one porous material of the permeate device, is fabricated, in whole or in part, from a fluoropolymer material (e.g., a fluoroethylene such as polytetrafluoroethylene), polyethersulfone, and/or stainless steel, a steel alloy or other metallic material or a rigid plastic that includes pre-defined apertures/channels or other openings that are configured and dimensioned to allow gas flow therethrough.

Additional features, functions and benefits of the disclosed apparatus, systems and methods will be apparent from the detailed description which follows, particularly when read in conjunction with the appended figures.

### BRIEF DESCRIPTION OF THE FIGURES

To assist those of skill in the art in making and using the disclosed apparatus, systems and methods, reference is made to the accompanying figures, wherein:

FIG. 1 is a flow chart for a process flow for nanoparticle formation using a permeate device;

FIG. 2 is a schematic cross-sectional view of an exemplary permeate device that may be used in the process flow of FIG. 1;

FIG. 3 is a schematic cross-sectional view of the permeate device of FIG. 2, modified to include sensors embedded/associated with the porous material;

FIG. 4 is a flow chart showing a liquid flow process that includes a permeate device;

FIG. 5 is an additional flow chart showing a liquid flow process that includes a permeate device and various additional equipment/accessories;

FIG. 6 is a further flow chart showing a liquid flow process that includes a permeate device and various additional equipment/accessories;

FIG. 7 is a flow chart showing a further liquid flow process that includes a permeate device and various additional equipment/accessories;

FIGS. 8A, 8B and 8C are schematic depictions of an exemplary permeate device that is associated with a vacuum chamber; and

FIG. 9 is a schematic depiction of a further exemplary permeate device that is associated with a vacuum chamber.

### DETAILED DESCRIPTION

Apparatus, systems and methods provide improved reduction and removal of gasses from a liquid flow stream. The apparatus, systems and methods effectuate the reduction and removal of gasses by way of a permeation device that generally includes (i) at least one non-porous, gas permeable element, structure or layer configured and dimensioned for direct contact with the liquid flow, and (ii) at least one element, structure or layer fabricated at least in part from a porous material or at least one element, structure or layer configured and dimensioned so as to permit gas flow therethrough. The element, structure or layer that permits gas flow therethrough is positioned outward of the at least one non-porous, gas permeable element, structure or layer. Gas that passes from the liquid flow and through the at least one non-porous, gas permeable element, structure or layer is brought into fluid communication with the element, structure or layer that permits gas flow therethrough. In this way, gas is permitted to pass from the liquid flow through a first element, structure or layer based on gas permeability, and then through a second element, structure or layer based on porosity and/or structural features of the second element, e.g., predefined openings therethrough.

The disclosed apparatus, systems and methods may be used in debubbling and degassing applications in various industries, e.g., to remove dissolved gas in a liquid phase that may cause processing issues, such as issues in downstream processing. For example, applicability may be found in the pharmaceutical, nutraceutical, cosmetics and food/beverage industries. Exemplary applications of the disclosed apparatus, systems and methods include, but are not limited to, liquid gas control, degassing liquids, gas humidification, gas exchange, gas dehumidification, liquid evaporation, volatile organic compound (VOC) detection and removal, pharmaceutical degassing, nutraceutical degassing, bioreactor gas control, blood oxygenation, pharmaceutical manufacturing, beverage manufacturing, cosmetic manufacturing and radon removal.

In an exemplary embodiment, the apparatus, systems and methods may be implemented and/or used in research and development operations, manufacturing operations and/or in the operations of contract development and manufacturing organizations (CDMOs), i.e., organizations that develop and/or manufacture products and/or processing techniques for a third party on a contract basis.

In an exemplary embodiment, the disclosed apparatus, systems and methods may be used in debubbling and degassing liquid flow systems that include nanoparticles. Nanoparticles are particles that are less than 1000 nanometers in diameter. Exemplary nanoparticles include liposomes, lipid nanoparticles, suspensions, micelles, emulsions, polymeric-lipid conjugate particles, and colloidal dispersions. In an exemplary embodiment, debubbling or degassing of a liquid flow that includes nanoparticles reduces dissolved gas molecules and/or reduces gas void volumes in internal structures of the nanoparticles. In an exemplary embodiment, debubbled or degassed liquid flows containing nanoparticles are stabilized by reducing dissolved gasses (e.g., oxygen) in the internal and external environment of the nanoparticles. In an exemplary embodiment, debubbling or degassing of a liquid flow that includes nanoparticles reduces oxidative stress on structural components of the nanoparticle and reduces particle degradation rates.

The disclosed permeate device includes at least one non-porous, gas permeable element, structure or layer configured and dimensioned for direct contact with the liquid flow. The non-porous, gas permeable element structure or layer allows gas molecules to permeate therethrough and prevent undesirable/unacceptable loss of nanoparticles in the degassing/debubbling operation.

The at least one non-porous, permeable element, structure or layer functions as a membrane that supports gas phase reduction.

The permeation rate of different dissolved species in a liquid flow stream is material dependent. An exemplary non-porous gas-permeable material for use in fabrication of the at least one non-porous, gas permeable element, structure or layer is silicone (polydimethylsiloxane). Alternative materials may be used in fabrication of the non-porous and gas permeable element. Suitable materials are non-porous, thereby preventing transfer of liquid and dissolved solids through the permeate device. Suitable materials exhibit gas permeability properties that permit permeation of gasses from a liquid stream through the element, structure or layer.

Silicone is compatible with many liquids and liquid mixtures and is permeable to many gasses. Different gasses permeate silicone by diffusion at different rates. Gas permeability is directly proportional to the gas solubility and the rate of diffusion of the dissolved gas through the permeable membrane.

The permeability coefficient is defined as the transport flux of a gas (rate of gas permeation per unit area), per unit transmembrane driving force, per unit membrane thickness. Table 1 provides silicone gas permeability coefficients for various gasses.

TABLE 1
GAS PERMEABILITIES IN DIMETHYLSILICONE
RUBBER (25%)

| | | Permeability* 10⁹, |
|---|---|---|
| | Chemical | (cm³ gas (RTP)*cm)/ |
| Gas Name | Formula | (sec*cm² *cm Hg ΔP) |
| Argon | Ar | 60 |
| Carbon dioxide | CO₂ | 325 |
| Carbon monoxide | CO | 34 |
| Ethylene | C₂H₄ | 135 |
| Helium | He | 35 |
| Hydrogen | H₂ | 65 |
| Methane | CH₄ | 95 |
| Nitric oxide | NO | 60 |
| Nitrogen | N₂ | 28 |
| Oxygen | O₂ | 60 |
| Water | H₂O | 3600 |

Hg = mercury
ΔP = change in pressure
cm = centimeter
sec = second
RTP = Room, Temperature, Pressure

In an exemplary embodiment, the at least one non-porous, gas permeable element, structure or layer configured and dimensioned for direct contact with the liquid flow is a silicone tube. The wall thickness of the silicone tube is generally selected so as to ensure structural integrity of the tube and to permit a desired level of gas permeation therethrough. For example, the wall thickness of the silicone tube may be about 0.002 inches to 0.008 inches. In an exemplary embodiment, the wall thickness of the silicone tube is 0.005 inches. The tensile strength of the silicone tube may be on the order of 1250 psi.

In an exemplary embodiment, a second element, structure or layer is associated with the non-porous, gas-permeable element, structure or layer. The second element provides structural support to the non-porous, gas-permeable element, structure or layer. For example, the second element provides sufficient structural support to the non-porous/gas-permeable element so as to maintain the structural integrity of the first element when exposed to the controlled vacuum and positive pressure conditions associated with operative use thereof.

The second element, structure or layer may be fabricated at least in part from a porous material or at least one element, structure or layer configured and dimensioned so as to permit gas flow therethrough. The second element, structure or layer may be fabricated, in whole or in part, from material(s) that provide structural support to the first element, structure or layer and that do not impede gas flow therethrough. For example, the second element, structure or layer may be fabricated, in whole or in part, from stainless steel, a steel alloy or a rigid plastic that includes pre-defined passage(s), e.g., apertures or channels, that permit unimpeded gas flow therethrough. Materials, such as polyetheretherketone, polyetherimide (PEI) material and stainless steel, may be implemented as component(s) in the layers or between the first/second element(s), structure(s) or layer(s).

In an exemplary embodiment, the second element is fabricated from porous polytetrafluoroethylene (PTFE). The thickness of the PTFE, may be about 0.007 inches. In an exemplary embodiment, a permeate device that includes a first element fabricated from silicone and a second element fabricated from PTFE may remove particle size down to 0.4 microns.

In an exemplary embodiment, the second element is fabricated from polypropylene plastic. The thickness of the polypropylene plastic may be about 0.125 inches. The polypropylene plastic element may include a plurality of spaced perforations to permit gas flow therethrough. In an exemplary embodiment, the spaced apertures have a diameter of about 0.1875 inches.

In an exemplary embodiment, the second element is fabricated from perforated steel. The perforations permit gas to flow therethrough. In an exemplary embodiment, the spaced apertures have a diameter of about 0.1875 inches.

In an exemplary embodiment, the second element is fabricated from a perforated steel alloy. The perforations permit gas to flow therethrough. In an exemplary embodiment, the spaced apertures have a diameter of about 0.1875 inches.

In an exemplary embodiment, the second element is fabricated from perforated stainless steel. The perforations permit gas to flow therethrough. In an exemplary embodiment, the spaced apertures have a diameter of about 0.1875 inches.

Under a controlled vacuum and positive pressure condition with a liquid flow through a closed fluid path, such as a silicone tube, gasses associated with the liquid stream may permeate through the non-porous, gas permeable silicone material. The magnitude of the positive pressure condition is typically based on the pump conditions for the liquid flow, the silicone tube diameter, the density/viscosity of the liquid stream and the temperature conditions associated with the operation. In exemplary embodiments, temperature conditions may range from about −65° F. to 400° F. The controlled vacuum is generally supplied by a vacuum source.

In an exemplary embodiment, the permeate device includes a vacuum chamber that surrounds an operative portion of (i) the at least one non-porous, gas permeable element, structure or layer, and (ii) the at least one element, structure or layer fabricated at least in part from a porous material or at least one element, structure or layer configured and dimensioned so as to permit gas flow therethrough. The vacuum chamber may take various geometric forms, e.g., rectangular, cylindrical, elliptical. The vacuum chamber sealingly engages the (i) the at least one non-porous, gas permeable element, structure or layer, and (ii) the at least one element, structure or layer fabricated at least in part from a porous material or at least one element, structure or layer configured and dimensioned so as to permit gas flow therethrough. The vacuum pressure may be in the 10-12 to 100 Torr pressure range. The combination of the positive pressure associated with the liquid flow and the negative pressure supplied by the vacuum source establishes the overall pressure differential that drives gas permeation through the non-porous and gas-permeable element, structure or layer.

The first element, structure or layer, e.g., the non-porous, gas permeable layer, generally defines a cylindrical flow path for the liquid flow, although alternative geometries may be employed. The first element, structure or layer may define a substantially axial flow path or may define non-axial flow paths, e.g., within the vacuum chamber. For example, the first element, structure or layer may define a substantially serpentine or tortuous path within the vacuum chamber, thereby increasing the residence time of the liquid within the vacuum chamber.

Assembly of the permeate device is generally devoid of epoxy and/or potting material(s). For example, the permeate device may be assembled such that the vacuum chamber sealingly engages the first element, structure or layer and the second element, structure or layer without the presence of epoxy and/or potting material(s). A gasket, washer or other non-epoxy based sealing member may be interposed between (i) the structure defining the vacuum chamber and (ii) the first element, structure or layer and the second element, structure or layer, i.e., the permeate device subassembly, to facilitate sealing therebetween.

In an exemplary embodiment, the throughput through the permeation device may be about 0.1 mL/min to 100 L/min.

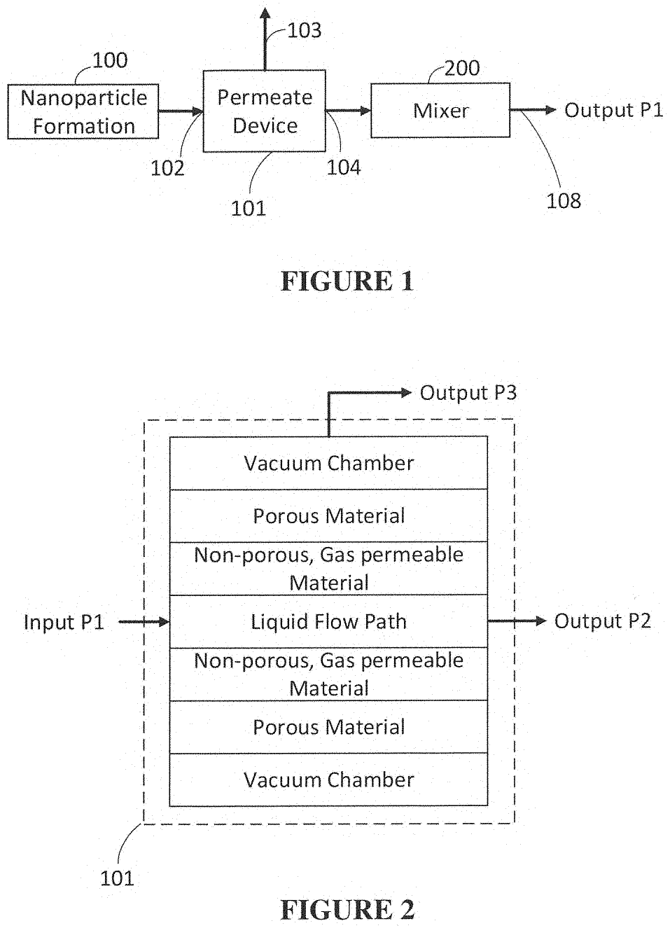

With reference to FIG. 1, a flowchart is provided that schematically depicts a nanoparticle formation unit operation. Nanoparticle formation and processing of a liquid stream that includes nanoparticles is an exemplary application of the disclosed permeate device. As noted above, nanoparticles are particles that are less than 1000 nanometers in diameter and include, for example, liposomes, lipid nanoparticles, suspensions, micelles, emulsions, polymeric-lipid conjugate particles, and colloidal dispersions.

As schematically depicted in FIG. 1, a nanoparticle-containing liquid stream is formed at step 100. The nanoparticle-containing liquid stream 102 is fed to a permeate device 101. The nanoparticle-containing liquid stream 102 may be fed to permeate device 101 by a pump, gravity feed or other processing technique. Permeate device 101 is effective in separating entrained gasses from the nanoparticle-containing liquid flow so as to deliver a degassed liquid flow 104 to a mixer unit 200. The entrained gasses that are separated from the nanoparticle-containing liquid stream 102 exit permeate device 101 as gas stream outflow 103. After undergoing mixing in mixer unit 200, an output P1 exits mixer unit 200 as Output P1 flow stream 108.

. In the exemplary implementation of FIG. 1, the liquid flow stream 102 that is fed into the permeate device 101 generally includes nanoparticles that are dissolved and/or entrained in the liquid flow stream 102 which includes gas and/or bubbles that are disadvantageous to the overall system operation. Thus, permeate device 101 functions to separate gas/bubbles from the input 102 and to discharge the separated gas/bubbles as gas stream outflow 103. The degassed/debubbled liquid flow effluent 104 from the permeate device 101 is fed into mixer unit operation 200 and, post-mixing, is discharged as output liquid flow 108, i.e., as output P1. Of note, the nanoparticle formation unit operation 100 and the mixer unit operation 200 may take various forms, depending on the industrial application of the disclosed technology. Additional unit operations may be included in the system, as will be apparent to persons skilled in the art and, as should be readily apparent, the intent of the flowchart of FIG. 1 is to illustrate that the disclosed permeate device 101 may be advantageously integrated into a liquid processing system that includes additional unit operations, including specifically a liquid processing system that entails, inter alia, nanoparticle formation (and inclusion in the liquid flow).

With reference to FIG. 2, a schematic cross-sectional view of an exemplary permeate device 101 is provided. As shown in FIG. 2, the liquid flow into permeate device 101, i.e., Input P1, passes through permeate device 101 and exits as Output P2. As the liquid flow passes through permeate device 101, the liquid flow contacts a non-porous, gas permeable material that advantageously allows permeation of gas/bubbles that are present in the liquid flow, while simultaneously preventing passage of non-gaseous flow constituents therethrough.

The non-porous, gas permeable material may take various forms, e.g., it may take the form of an element, structure or layer. The non-porous, gas permeable material is configured and dimensioned for direct contact with the liquid flow. For example, the non-porous, gas permeable material may take the form of a tube, pipe or enclosed channel.

The permeate device schematically depicted in the cross-sectional view of FIG. 2 may provide a cylindrical flow passage through permeate device 101 (such that the non-porous, gas permeable material of permeate device 101 surrounds a cylindrical flow path), but the present disclosure is not limited by or to a cylindrical flow passage. Rather, various geometries may be employed, so long as the liquid flow is brought into contact with the surface of the non-porous, gas-permeable material.

External to or outward of the non-porous, gas permeable material is/are one or more porous material(s) that define at least one element, structure or layer fabricated at least in part from a porous material or at least one element, structure or layer configured and dimensioned so as to permit gas flow therethrough. Gas that passes from the liquid flow and through the at least one non-porous, gas permeable material is brought into fluid communication with the element, structure or layer that permits gas flow therethrough, i.e., the porous material. In this way, gas is permitted to pass from the liquid flow through a first element, structure or layer based on gas permeability, and then through a second element, structure or layer based on porosity and/or structural features of the second element, e.g., predefined openings therethrough.

In an exemplary cylindrical implementation of the disclosed permeate device 101, the porous material layer(s) is/are radially outward of the non-porous, gas permeable material/layer(s) (and, by extension, radially outward of the liquid flow path itself).

Permeate device 101 may include a vacuum chamber that encases the non-porous, gas permeable material and the porous material and is in communication with a vacuum source (e.g., a vacuum pump), such that a negative pressure is established within the vacuum chamber. The vacuum chamber sealingly engages the non-porous, gas permeable material and/or the porous material. The negative pressure in the vacuum chamber functions to draw gas/bubbles from and through the porous material layer(s) and the non-porous, gas permeable material(s), thereby removing/separating such gas/bubbles from the liquid flow.

The withdrawn gas/bubbles—which are substantially devoid of nanoparticles and non-gaseous constituents of Input P1—forms Output P3 from permeate device 101. Of note, Output P3 is schematically depicted exiting the permeate device 101 in a single location. However, it is to be understood that Output P3 may flow from the permeate device 101 in different/multiple locations, e.g., based on the means by which the vacuum source interacts with the vacuum chamber. Output P2 represents the liquid flow that exits permeate device 101 with gas/bubbles extracted therefrom.

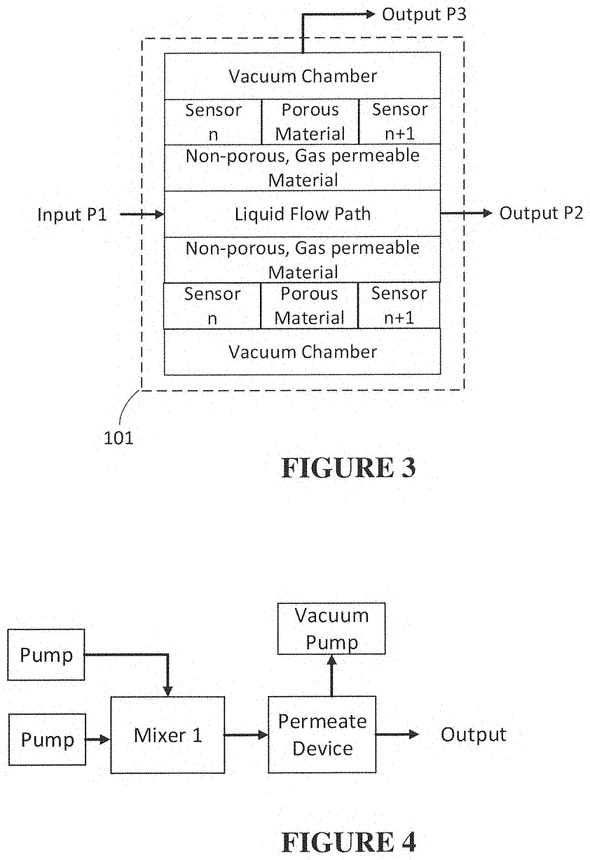

Turning to FIG. 3, a modified version of FIG. 2 is provided, wherein permeate device 101 is modified such that the porous material includes “Sensor n” and “Sensor n+1”. Permeate device 101 may include one or more of the schematically depicted sensors. Thus, permeate device 101 may include only a single sensor, e.g., Sensor n, or two sensors, e.g., Sensor n and Sensor n+1, or more than two sensors (not schematically depicted). Exemplary sensors that may be embedded in or otherwise associated with permeate device 101, e.g., embedded in the porous material/layer, are pressure sensor(s), temperature sensor(s), refractive index sensor(s) and/or gas sensor(s).

FIG. 4 provides a flow chart for a liquid process that illustrates an exemplary processing modality wherein a pair of pumps deliver input to a Mixer 1 prior to introduction of a liquid flow to the permeate device. The constituents that are delivered to Mixer 1 by the two pumps is dependent on the industrial application of the system, as will be readily apparent to persons skilled in the art. The disclosed system/method has wide ranging applicability and the two pumps may be used to deliver many different constituents/feedstocks to Mixer 1, as may be elected by the system user.

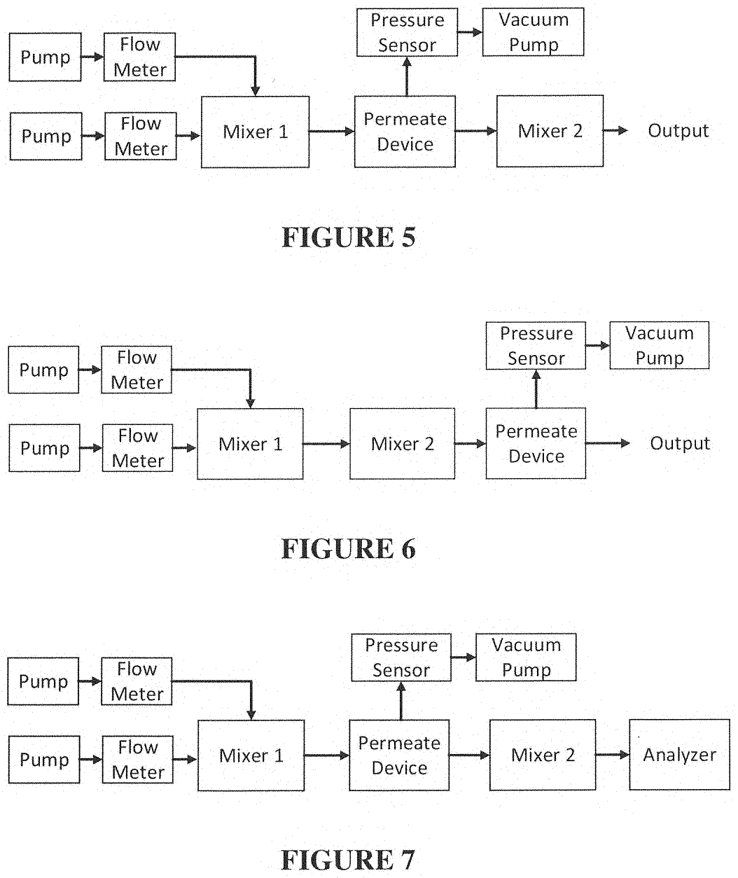

FIG. 5 provides a further flow chart schematically depicting a further industrial application of the disclosed permeate device. The two pumps shown in FIG. 4 deliver liquid flow to Mixer 1 through first/second flow meters, thereby allowing the user(s) to monitor and/or preset the rate of flow of the respective constituents into Mixer 1. The permeate device is shown interacting with a vacuum pump and a pressure sensor (that is interposed between the permeate device and the vacuum pump) to measure and/or control the vacuum level delivered to the permeate device. A second mixer—Mixer 2—is positioned downstream of the permeate device and operates to re-mix the liquid flow after the degassing/debubbling operation of the permeate device.

FIG. 6 provides an additional flow chart schematically depicting an additional exemplary industrial application of the disclosed permeate device. The two pumps shown in FIGS. 4 and 5 deliver liquid flow to Mixer 1 by way of first/second flow meters, thereby allowing the user(s) to monitor and/or preset the rate of flow of the respective constituents into Mixer 1. A second mixer—Mixer 2—is positioned downstream of Mixer 1 and functions to provide enhanced mixing of the constituents before delivery to the permeate device. As with FIG. 5, the permeate device is shown interacting with a vacuum pump and a pressure sensor (that is interposed between the permeate device and the vacuum pump) to measure and/or control the vacuum level delivered to the permeate device.

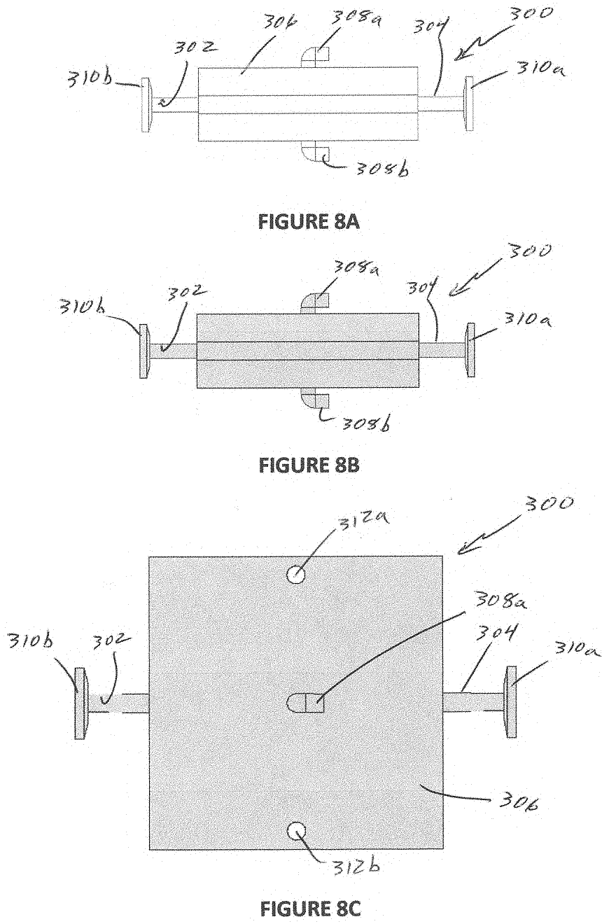

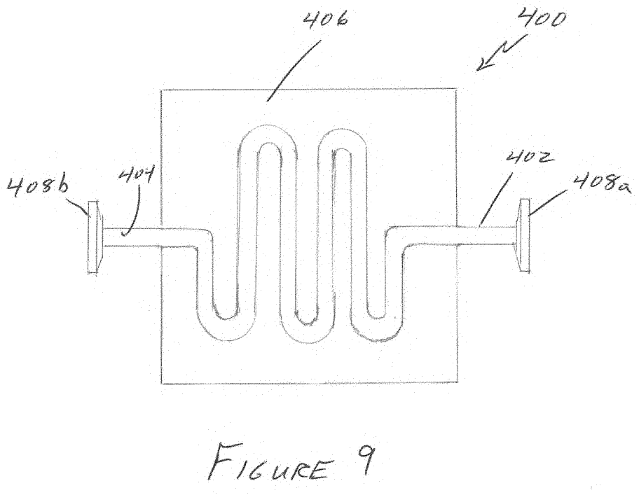

FIG. 7 provides a further flow chart schematically depicting an additional exemplary application of the disclosed permeate device. As with FIG. 6, the two pumps deliver liquid flow to Mixer 1 by way of first/second flow meters, thereby allowing the user(s) to monitor and/or preset the rate of flow of the respective constituents into Mixer 1. A second mixer—Mixer 2—is positioned downstream of Mixer 1 and functions to provide enhanced mixing of the constituents before delivery to the permeate device. As with FIGS. 5 and 6, the permeate device is shown interacting with a vacuum pump and a pressure sensor (that is interposed between the permeate device and the vacuum pump) to measure and/or control the vacuum level delivered to the permeate device. The output from Mixer 2 is delivered to an Analyzer for analysis of the content of the liquid flow after having been processed through the mixers and permeate device.

FIGS. 8A, 8B and 8C are schematic depictions of an exemplary permeate device 300. FIGS. 8A and 8B are schematic side views. FIG. 8C is a schematic top view. Permeate device 300 includes a non-porous, gas permeable element 302 configured and dimensioned for direct contact with a liquid flow. Permeate device 300 also includes an element 304 fabricated at least in part from a porous material or configured and dimensioned so as to permit gas flow therethrough. As shown in FIGS. 8A and 8B, element 304 that permits gas flow therethrough is positioned outward of the a non-porous, gas permeable element 302. Element 304 provides structural support and enhances structural integrity of element 302, e.g., when element 302 is subject to a positive pressure based on pumping of liquid flow therethrough and/or a negative pressure based on a vacuum being applied to the external surface of element 302.

An operative portion of elements 302 and 304 of permeate device 300 is positioned within a vacuum chamber 306. Vacuum chamber 306 includes fittings 308a, 308b for connection to a vacuum source. In the exemplary embodiment of FIGS. 8A and 8B, elements 302 and 304 define a substantially axial flow path through vacuum chamber 306. The flow path through the vacuum chamber may take various forms, e.g., the flow path may be a sinusoidal, zig-zag, spiral or tortuous path, thereby increasing the residence time of the liquid stream within the vacuum chamber.

Element 302 of permeate device 300 may be in fluid communication with flanges or sanitary fittings 310a, 310b to facilitate fluid connection of permeate device 300 relative to upstream and downstream operations. For example, one or more permeate devices 300 may be positioned within an industrial processing operation to effectuate degassing/debubbling of the liquid flow at one or more points in the processing operation by connecting the flanges/sanitary fittings 310a, 310b relative to cooperative structures associated with the processing operation.

As schematically depicted in FIG. 8C, apertures 312a, 312b may be formed in vacuum chamber 306 to facilitate assembly and/or mounting of vacuum chamber 306. For example, vacuum chamber 306 may be defined by first and second cooperative structures that are configured and dimensioned to be joined to each other with elements 302, 304 passing therethrough, e.g., as clam shell elements. Apertures 312a, 312b may be used for introduction of bolts or other joining elements so as to join the first/second cooperative structures that together form vacuum chamber 306. The vacuum chamber 300 may be assembled without the use of epoxy or other potting material(s).

The cooperative elements that together form vacuum chamber 306 generally define openings in end(s) thereof to permit passage of elements 302, 304 therethrough. When assembled, vacuum chamber 306 sealingly engages relative to elements 302, 304 so as to maintain a vacuum therewithin when a negative pressure is delivered to vacuum chamber, e.g., from a vacuum source by way of fitting(s) 308a, 308b. Apertures 312a, 312b may be positioned at various locations on the face of the vacuum chamber structures, and may number more or less than the two apertures schematically depicted in FIGS. 8A and 8B. In an exemplary embodiment, the bolts or other joining elements may be torqued so as to secure the vacuum chamber structures relative to each other and the confronting portions of the vacuum chamber structures may then be welded to further ensure sealing integrity of the vacuum chamber.

FIG. 9 is a schematic depiction of an exemplary permeate device 400. Permeate device 400 includes a non-porous, gas permeable element 402 configured and dimensioned for direct contact with a liquid flow. Permeate device 400 also includes an element 404 fabricated at least in part from a porous material or configured and dimensioned so as to permit gas flow therethrough. As shown in FIG. 9, element 404 that permits gas flow therethrough is positioned outward of the non-porous, gas permeable element 402. Element 404 provides structural support and enhances structural integrity of element 402, e.g., when element 402 is subject to a positive pressure based on pumping of liquid flow therethrough and/or a negative pressure based on a vacuum being applied to the external surface of element 402.

An operative portion of elements 402 and 404 of permeate device 400 is positioned within a vacuum chamber 406. Vacuum chamber 406 includes fittings 408a, 408b for connection to a vacuum source. In the exemplary embodiment of FIG. 9, elements 402 and 404 define a sinusoidal flow path through vacuum chamber 406. The sinusoidal flow path through vacuum chamber 406 includes five (5) 180° turns of elements 402, 404, thereby increasing the residence time of the liquid stream within the vacuum chamber 406 as compared with an axial flow path. The exemplary sinusoidal flow path schematically depicted in FIG. 9 may be adjusted to include more or less turns. Alternative non-axial flow paths for elements 402, 404 may be implemented.

Element 402 of permeate device 400 may be in fluid communication with flanges or sanitary fittings 410a, 410b to facilitate fluid connection of permeate device 400 relative to upstream and downstream operations. For example, one or more permeate devices 400 may be positioned within an industrial processing operation to effectuate degassing/debubbling of the liquid flow at one or more points in the processing operation by connecting the flanges/sanitary fittings 410a, 410b relative to cooperative structures associated with the processing operation. The permeate devices may include the same or different flow paths within their respective vacuum chambers. In an exemplary embodiment, different flow paths are provided in the respective permeate devices, thereby providing different vacuum chamber residence times at various stages in the processing regimen.

The present disclosure provides apparatus, systems and methods for processing liquids. In an exemplary embodiment, the disclosed apparatus, systems and methods may be used in applications for degassing or gas reduction of liquids containing nanoparticles. Exemplary features and/or functions of the disclosed apparatus, systems and methods include, without limitation, the following—which may be integrated together into a single implementation or which may be selectively integrated into such implementation.

Material of construction for the nonporous, gas permeable membrane may be silicone or any other gas permeable membrane.

Material of construction for the nonporous, gas permeable membrane may be less than 1 mm in thickness.

Material of construction for the porous material may be a stainless-steel, where the stainless steel is, for example, a mesh with a high degree of porosity.

Material of construction of the porous material may be a fluoropolymer such as polytetrafluoroethylene (PTFE) or other fluoroethylene material(s). In exemplary implementations, the PTFE has a high degree of porosity, e.g., >70%.

Material of construction of the porous material may be polyethersulfone.

The liquid flow path may be fabricated from stainless steel, in whole or in part.

The liquid flow path may be fabricated from a plastic, in whole or in part.

The permeate device may be fabricated from polyetheretherketone, polyetherimide (PEI) material and stainless steel, in whole or in part.

The permeate device may be fabricated using additive manufacturing and/or 3D printing.

The geometry of the liquid flow path may be selected to offer increased gas permeability and/or increased residence time in the gas permeation zone.

The liquid flow path may be configured and operate such that the liquid changes direction in the gas permeation device. Small corners with various angles may be implemented in the design to enable liquid to flow back and forth in the liquid flow path as the liquid moves downstream from the liquid inlet.

The liquid flow path may be positioned to have the liquid flow in a vertical direction.

One or more sensors may be embedded or otherwise positioned in the permeate device/zone, e.g., by embedding sensor(s) in the porous material.

Exemplary sensor(s) for inclusion in the permeate device/zone include pressure, temperature, refractive index and/or gas sensors.

The liquid flow path may bring the liquid flow into contact with temperature, pressure, refractive index and/or dissolved gas sensors.

Multiple, stackable permeate devices/zones can be combined to provide increased gas permeability to the system/processing method. The permeate zones refer to one channel or liquid flow path. The permeate zone has an inlet and an outlet. Multiple zones may be stacked or otherwise placed in series to form a permeate device that has increased surface area for permeation therethrough.

The surface area of the non-porous silicone may be tuned to the amount of gas to dissolve related to specific liquid flow rates.

The gas permeation device may further comprise a stainless-steel holder torqued to a specific rating to support a desired transmembrane pressure, e.g., a transmembrane pressure up to 1000 psi.

The gas permeation device may further include a holder that is plastic.

The gas permeation device may further include a holder that is intended for single-use.

The gas permeation device may further be intended for single-use.

The permeation device/zone may include a matrix of a porous material that is coated, in whole or in part, with a non-porous material. The porous material may be dense and may be fabricated from a material of the type disclosed above, e.g., a fluoropolymer such as polytetrafluoroethylene. The non-porous coating for the porous material may be, for example, silicone.

All statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Various other components may be included and called upon for providing for aspects of the teachings herein. For example, additional materials, combinations of materials and/or omission of materials may be used to provide for added embodiments that are within the scope of the teachings herein. Adequacy of any particular element for practice of the teachings herein is to be judged from the perspective of a designer, manufacturer, seller, user, system operator or other similarly interested party, and such limitations are to be perceived according to the standards of the interested party.

In the disclosure hereof any element expressed as a means for performing a specified function is intended to encompass any way of performing that function including, for example, a) a combination of circuit elements and associated hardware which perform that function or b) software in any form, including, therefore, firmware, microcode or the like as set forth herein, combined with appropriate circuitry for executing that software to perform the function. Applicants thus regard any means which can provide those functionalities as equivalent to those shown herein. No functional language used in claims appended herein is to be construed as invoking 35 U.S.C. § 112(f) interpretations as “means-plus-function” language unless specifically expressed as such by use of the words “means for” or “steps for” within the respective claim.

When introducing elements of the present invention or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements. The term “exemplary” is not intended to be construed as a superlative example but merely one of many possible examples.

1. A permeate device, comprising:
a. at least one non-porous, gas permeable element configured for direct contact with a liquid flow, the non-porous, gas permeable element configured to support gas phase reduction of the liquid flow; and
b. at least one porous element fabricated at least in part from a porous material, the porous element configured to provide structural support to the non-porous, gas permeable element and permit gas flow therethrough.

2. The permeate device of claim 1, further comprising a vacuum chamber that surrounds at least an operative portion of (i) the at least one non-porous, gas permeable element, and (ii) the at least one porous element.

3. The permeate device of claim 2, wherein the vacuum chamber is in fluid communication with a vacuum source.

4. The permeate device of claim 2, wherein the vacuum chamber sealingly engages the operative portion of (i) the at least one non-porous, gas permeable element and (ii) the at least one porous element, wherein the sealing engagement is provided in the absence of an epoxy or potting material.

5. The permeate device of claim 1, wherein the at least one non-porous, gas permeable element defines a flow path for the liquid flow.

6. The permeate device of claim 5, wherein the flow path comprises one of an axial flow path and a non-axial flow path.

7. The permeate device of claim 6, wherein the non-linear flow path comprises one of a sinusoidal flow path, a zig-zag flow path, spiral flow path and a tortuous flow path.

8. The permeate device of claim 1, wherein the at least one non-porous, gas permeable element is fabricated, in whole or in part, from silicone.

9. The permeate device of claim 1, wherein the at least one porous element is fabricated, in whole or in part, from a fluoropolymer material or polyethersulfone.

10. The permeate device of claim 1, further comprising one or more sensors positioned in association with the at least one porous element.

11. The permeate device of claim 10, wherein the one or more sensors are selected from the group consisting of a pressure sensor, a temperature sensor, a refractive index sensor, a gas sensor, and combinations thereof.

12. The permeate device of claim 1, wherein the at least one porous element is fabricated, at least in part, from a metal or plastic that includes predefined openings configured and dimensioned for gas molecule passage.

13. A method for processing a liquid flow to remove entrained gas, comprising:
a. providing a liquid flow that includes an initial level of entrained gas;
b. delivering the liquid flow to a permeate device, wherein the permeate device includes (i) at least one non-porous, gas permeable element configured for direct contact with a liquid flow, the non-porous, gas permeable element configured to support gas phase reduction of the liquid flow; and (ii) at least one porous element fabricated at least in part from a porous material, the porous element configured to provide structural support to the non-porous, gas permeable element and permit gas flow therethrough;
c. applying a negative pressure to the permeate device to draw entrained gas through (i) the at least one non-porous, gas permeable element configured for direct contact with a liquid flow, the non-porous, gas permeable element configured to support gas phase reduction of the liquid flow. and (ii) the at least one porous element fabricated at least in part from a porous material, the porous element configured to provide structural support to the non-porous, gas permeable element and permit gas flow therethrough.

14. The method of claim 13, wherein the permeate device includes a vacuum chamber that sealingly engages (i) the at least one non-porous, gas permeable element, and (ii) the at least one porous element.

15. The method of claim 14, wherein the vacuum chamber sealingly engages (i) the at least one non-porous, gas permeable element, and (ii) the at least one porous element.

16. The method of claim 13, further comprising mixing constituents of the liquid flow prior to the delivering.

17. The method of claim 13, wherein the negative pressure is in the range of 10-12 to 100 Torr.

18. The method of claim 13, wherein the applying reduces dissolved gas molecules in the liquid flow.

19. The method of claim 13, wherein the liquid flow includes nanoparticles and wherein the applying reduces gas void volumes in internal structures of the nanoparticles.

20. A permeate device, comprising:
a combination of at least one non-porous, gas permeable element configured for direct contact with a liquid flow, the non-porous, gas permeable element configured to support gas phase reduction of the liquid flow; and at least one porous element fabricated at least in part from a porous material, the porous element configured to provide structural support to the non-porous, gas permeable element and permit gas flow therethrough;
wherein the combination is disposed in a vacuum chamber providing at least one of a sinusoidal flow path, a zig-zag flow path, a spiral flow path and a tortuous flow path;
wherein at least one of the combination is configured to sealingly engage a source of negative pressure for reducing gas entrained in the liquid flow.
